(19) United States
(12) Patent Application Publication
(10) Pub. No.: US 2010/0007722 A1
(43) Pub. Date: Jan. 14, 2010

(54) STEREOSCOPIC IMAGE DISPLAY DEVICE AND DRIVING METHOD THEREOF

(76) Inventor: Ul-Je Kim, Suwon-si (KR)

Correspondence Address: CHRISTIE, PARKER & HALE, LLP, PO BOX 7068, PASADENA, CA, 91109-7068, US

(21) Appl. No.: 12/497,422

(22) Filed: Jul. 2, 2009

(30) Foreign Application Priority Data
Jul. 14, 2008 (KR) 10-2008-0068118

(51) Int. Cl. H04N 13/04; G09G 5/00

(52) U.S. Cl. 348/53; 345/204

(57) ABSTRACT

A stereoscopic image display device and method for driving the same includes a plasma display device and spectacles. A 3D effect is produced by turning on the left-eye lens of the spectacles in synchronization with a left-eye image and turning on the right-eye lens of the spectacles in synchronization with a right-eye image. The left-eye image is displayed on a group of discharge cells on the plasma display device during one frame, and the right-eye image is displayed on another group of discharge cells during the next frame. The cells displaying the left-eye image have an idle period while the right-eye image is displayed, and the cells displaying the right-eye image have an idle period while the left-eye image is displayed. Thus, the cells are not continuously discharged so an afterglow phenomenon of the discharge cells is reduced.

### CROSS-REFERENCE TO RELATED APPLICATION

This application claims priority to and the benefit of Korean Patent Application No. 10-2008-0068118 filed in the Korean Intellectual Property Office on Jul. 14, 2008, the entire content of which is incorporated herein by reference.

### BACKGROUND OF THE INVENTION

1. Field of the Invention

The present invention relates to a stereoscopic image display device and a method for driving the same.

2. Description of the Related Art

A plasma display device is a display device using a plasma display panel for displaying characters or images by using plasma generated from gas discharge. The plasma display panel includes a plurality of cells arranged in a matrix form. The plasma display device displays an image by dividing one frame into a plurality of subfields and driving them.

In the plasma display device, one frame is divided into a plurality of respectively weighted subfields, and the subfields are driven. During an address period of each subfield, a scan pulse is sequentially applied to a plurality of scan electrodes to selectively turn-on or turn-off cells, and during a sustain period, a high level voltage and a low level voltage of a sustain discharge pulse are alternately applied to electrodes to perform a sustain discharge operation on the turn-on cells so as to display an image.

Such a plasma display device has excellent performance among displays capable of displaying a stereoscopic (3D) image. In three-dimensional image display technology, a 3D effect of an object is created using binocular parallax, which is a primary factor in recognizing a 3D effect at a short distance. The plasma display device drives 120 frames per second in order to display a stereoscopic image, and alternately displays a left-eye image and a right-eye image at 1/120 second intervals. In a case where a left-eye image and a right-eye image are alternately displayed at 1/120 second intervals, this leads to a problem when persistence of phosphor in the plasma display device causes an afterglow.

The above information disclosed in this background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention are directed toward a stereoscopic image display device and method for driving the same, which can reduce an afterglow phenomenon.

An embodiment of the present invention provides a stereoscopic image display device, including a plasma display panel including a plurality of first electrodes, a plurality of second electrodes, a plurality of third electrodes crossing the plurality of first and second electrodes, and a plurality of cells defined by the plurality of first and second electrodes; spectacles including a left-eye lens and a right-eye lens configured to be turned on and off; a controller for alternately outputting a first control signal for displaying a left-eye image on a first group of cells of the plurality of cells and a second control signal for displaying a right-eye image on a second group of cells of the plurality of cells; and a driver for driving the first, second, and third electrodes in response to the control signals from the controller, wherein the left-eye lens is configured to turn on in response to the first control signal, and the right-eye lens is configured to turn on in response to the second control signal.

Another embodiment of the present invention provides a method for driving a stereoscopic image display device, the stereoscopic image display device including a plasma display panel including a plurality of cells for displaying images and spectacles including a left-eye lens and a right-eye lens, the method including displaying a left-eye image on a first group of cells of the plurality of cells, turning on the left-eye lens, and turning off the right-eye lens, and displaying a right-eye image on a second group of cells of the plurality of cells, turning on the right-eye lens, and turning off the left-eye lens.

Yet another embodiment of the present invention provides a stereoscopic image display device, including: a plasma display panel including a plurality of cells; and spectacles including a left-eye lens and a right-eye lens, each lens configured to alternately turn on and off, wherein the stereoscopic image display device is configured to display an image on a first group of cells of the plurality of cells in response to an input image signal during a first period, display an image on a second group of cells of the plurality of cells in response to an input image signal during a second period, turn on either the left-eye lens or the right-eye lens in synchronization with a first point of time of the first period, and turn off either the left-eye lens or the right-eye lens in synchronization with a second point of time of the second period.

### BRIEF DESCRIPTION OF THE DRAWINGS

FIG. 1 is a view showing a stereoscopic image display device according to an exemplary embodiment of the present invention.

FIG. 2 is a view showing a plasma display device according to an exemplary embodiment of the present invention.

FIG. 3 is a view showing a cycle for displaying a left-eye image and a right-eye image according to an exemplary embodiment of the present invention.

FIGS. 4A and 4B are views showing a method for displaying a left-eye image and a right-eye image of a plasma display panel according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

A stereoscopic image display device and method for driving the same according to an exemplary embodiment of the present invention will be described in detail with reference to the accompanying drawings.

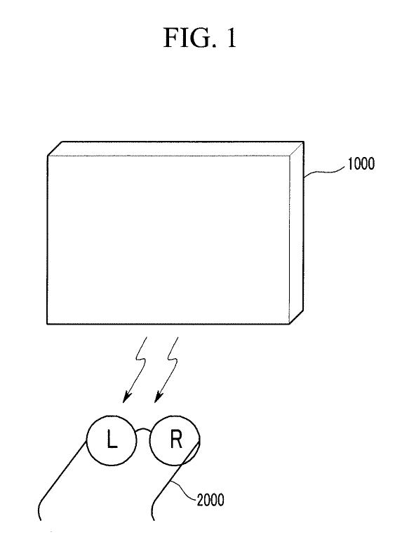

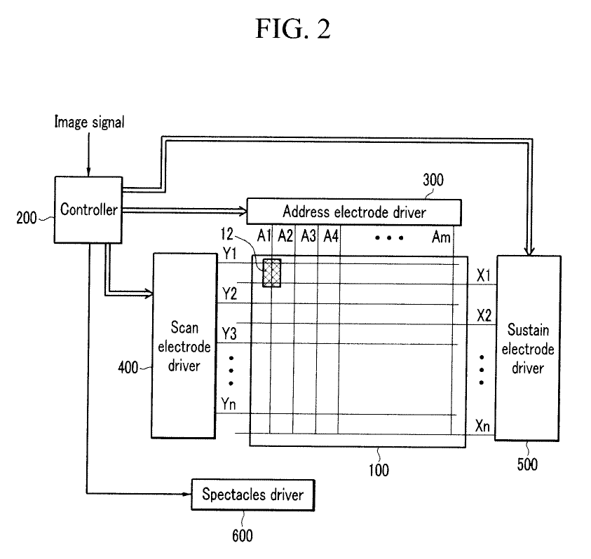

FIG. 1 is a view showing a stereoscopic image display device according to an exemplary embodiment of the present invention. FIG. 2 is a view showing a plasma display device according to an exemplary embodiment of the present invention.

As shown in FIG. 1, the stereoscopic image display device according to the present invention includes a plasma display device 1000 and spectacles 2000 driven in synchronization with an image displayed on the plasma display device 1000. The spectacles 2000 include a left-eye lens L for viewing a left-eye image and a right-eye lens R for viewing a right-eye image. The left-eye lens L and the right-eye lens R are alternately shuttered in synchronization with the plasma display device 1000. In addition, the spectacles 2000 of the present invention receive a control signal sent from the plasma display device 1000 through a receiving apparatus. The control signal may be communicated wirelessly or by wire. The spectacles 2000 shutter the left-eye lens L and the right-eye lens R in response to the received control signal. The lenses (L, R) are made of a device, such as an LCD, that is capable of blocking the field of view.

Generally, an image seen through a person's left eye and an image seen through the person's right eye are different. For the stereoscopic image display device, a left-eye image is an image to be perceived by a viewer's left eye, and a right-eye image is an image to be perceived by the viewer's right-eye. A difference between the left-eye image and the right-eye image generates a binocular parallax.

During a period when the left-eye image is displayed on the plasma display device 1000, the left-eye lens L is a transmission or transparent region, and the right-eye lens R is a non-transmission or opaque region. During a period when the right-eye image is displayed on the plasma display device 1000, the right-eye lens R is a transmission or transparent region, and the left-eye lens L is a non-transmission or opaque region. Hereinafter, when the left-eye lens or the right-eye lens is a transmission or transparent region, this is referred to as ON, and when the left-eye lens or the right-eye lens is a non-transmission or opaque region, this is referred to as OFF. Switching the left-eye lens L and the right-eye lens R from ON to OFF is referred to as shuttering.

As shown in FIG. 2, the plasma display device according to the exemplary embodiment of the present invention includes a plasma display panel 100, a controller 200, an address electrode driver 300, a scan electrode driver 400, a sustain electrode driver 500, and a spectacles driver 600.

The plasma display panel 100 includes a plurality of sustain electrodes (hereinafter, also referred to as “X electrodes”) X1 to Xn extending in a row direction and a plurality of scan electrodes (hereinafter, also referred to as “Y electrodes”) Y1 to Yn, which are paired with corresponding sustain electrodes, extending in a row direction. The plasma display panel also includes a plurality of address electrodes (hereinafter, also referred to as “A electrodes”) A1 to Am extending in a column direction. Generally, the X electrodes X1 to Xn are formed corresponding to the Y electrodes Y1 to Yn, and the X electrodes X1 to Xn and the Y electrodes Y1 to Yn are utilized to perform a display operation for displaying an image in a sustain period. The Y electrodes Y1 to Yn cross the address electrodes A1 to Am, and the X electrodes X1 to Xn cross the address electrodes A1 to Am. Discharge spaces provided at regions where the address electrodes A1 to Am cross the X and Y electrodes X1 to Xn and Y1 to Yn form cells 12. The structure of the plasma display panel 100 shows one example, and a panel with a different structure may be used in embodiments of the present invention.

The controller 200 receives an external image signal and outputs an A electrode drive control signal, an X electrode drive control signal, and a Y electrode drive control signal. The controller 200 divides one frame into a plurality of subfields for driving. Each subfield includes a reset period, an address period, and a sustain period in a temporal sequence.

The controller 200 divides the received image signal into a left-eye image signal and a right-eye image signal. The controller 200 generates the A electrode drive control signal, the X electrode drive control signal, and the Y electrode drive control signal in order to display images in response to the left-eye and right-eye image signals. The controller 200 outputs a spectacles drive control signal for alternately shuttering the left-eye lens L and right-eye lens R of the spectacles 2000 in synchronization with the left-eye image and the right-eye image. Hereinafter, the A electrode drive control signal, X electrode control signal, and Y electrode control signal generated by the controller 200 in response to the left-eye image signal are referred to as left-eye image control signals, and the A electrode drive control signal, X electrode control signal, and Y electrode control signal generated by the controller 200 in response to the right-eye image signal are referred to as right-eye image control signals.

The address electrode driver 300 receives the A electrode drive control signal from the controller 200 and applies a display data signal for selecting desired discharge cells to the respective A electrodes. During a period for displaying the left-eye image, the address electrode driver 300 according to the exemplary embodiment of the present invention delivers a data signal having a non-emission voltage level to a cell for displaying the right-eye image (hereinafter, right-eye image cell). During a period for displaying the right-eye image, the address electrode driver 300 delivers a data signal having the non-emission voltage level to a cell for displaying the left-eye image (hereinafter, left-eye image cell). The non-emission voltage level indicates a level at which cells are not emitted and may be a ground voltage.

The scan electrode driver 400 receives the Y electrode drive control signal from the controller 200 and applies a driving voltage to the Y electrodes.

The sustain electrode driver 500 receives the X electrode drive control signal from the controller 200 and applies a driving voltage to the X electrodes.

The spectacles driver 600 receives a spectacles drive control signal from the controller 200 and alternately shutters the left-eye lens L and right-eye lens R of the spectacles 2000. The spectacles driver 600 wirelessly sends a control signal for shuttering the left-eye lens L and right-eye lens R of the spectacles 2000.

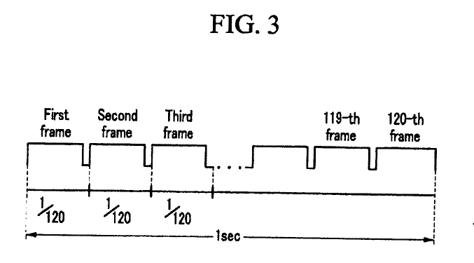

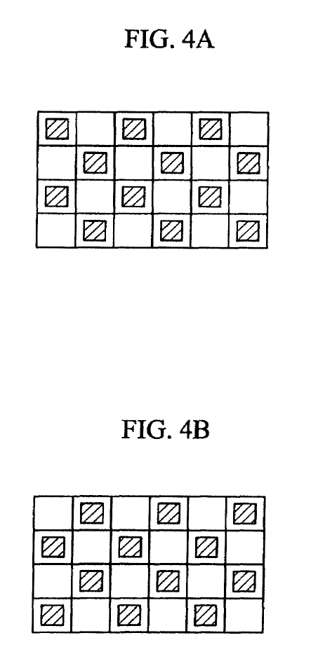

FIG. 3 is a view showing a cycle for displaying a left-eye image and a right-eye image. FIGS. 4A and 4B are views showing a method for displaying a left-eye image and a right-eye image of a plasma display panel according to an exemplary embodiment of the present invention.

Although FIG. 3 shows a signaling system that operates at a 120 Hz frequency, the present invention is not limited thereto. The signal system is applicable to signaling systems, for example, PAL or NTSC, that operate at other frequencies. In FIGS. 4A and 4B, one square indicates one cell, cells indicated by [symbol] (i.e., a cross-hatched square) are cells that do not emit light regardless of an image signal, and cells not indicated by [symbol] (i.e., a cross-hatched square) are cells that emit light in response to an image signal.

As shown in FIG. 3, in a signaling system that operates at a 120 Hz frequency, one frame time is 1/120 second. Accordingly, the controller 200 outputs the left-eye image control signal for displaying the left-eye image during a first 1/120 second period to the respective drivers 300, 400, and 500 and the spectacles driver 600.

As shown in FIG. 4A, in the exemplary embodiment of the present invention, the controller 200 selects cells in a dot pattern in which left-eye image cells are not adjacent to each other. When the left-eye image is displayed, the spectacles driver 600 is synchronized with the spectacles drive control signal from the controller 200 and turns the left-eye lens L ON and turns the right-eye lens R OFF. Thus, the user can see a left-eye image for 1/120 second.

During a second 1/120 second period, the controller 200 outputs a right-eye image control signal for displaying a right-eye image to the respective drivers 300, 400, and 500 and the spectacles driver 600. As shown in FIG. 4B, in the exemplary embodiment of the present invention, the controller 200 selects right-eye image cells distinct from the left-eye image cells. When a right-eye image is displayed, the spectacles driver 600 is synchronized with a spectacles drive control signal from the controller 200 and turns the right-eye lens R ON and turns the left-eye lens L OFF. Thus, the user can see a right-eye image for 1/120 second.

In the exemplary embodiment of the present invention, the left-eye image is displayed on discharge cells having a dot pattern during one frame, and the right-eye image is displayed on discharge cells having another dot pattern during the next frame. In addition, a 3D effect may be produced by giving parallax to both eyes as the left-eye lens of the spectacles is turned ON in synchronization with the left-eye image, and the right-eye lens of the spectacles is turned ON in synchronization with a right-eye image. The cells displaying the left-eye image have an idle period while the plasma display panel is displaying the right-eye image, and the cells displaying the right-eye image have an idle period while the plasma display panel is displaying the left-eye image. Thus, the cells are not continuously discharged thereby reducing afterglow phenomenon of the discharge cells. Degradation in luminance caused by the idle period may be recovered by doubling the intensity of light during the non-idle period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stereoscopic image display device, comprising:
a plasma display panel comprising a plurality of first electrodes, a plurality of second electrodes, a plurality of third electrodes crossing the plurality of first and second electrodes, and a plurality of cells defined by the plurality of first and second electrodes;
spectacles comprising a left-eye lens and a right-eye lens configured to be turned on and off;
a controller for alternately outputting a first control signal for displaying a left-eye image on a first group of cells of the plurality of cells and a second control signal for displaying a right-eye image on a second group of cells of the plurality of cells; and
a driver for driving the first, second, and third electrodes in response to the control signals from the controller,
wherein the left-eye lens is configured to turn on in response to the first control signal, and the right-eye lens is configured to turn on in response to the second control signal.

2. The stereoscopic image display device of claim 1, wherein the first and second groups of cells have no cells in common.

3. The stereoscopic image display device of claim 1, wherein each cell of the first group of cells is adjacent to a cell of the second group of cells.

4. The stereoscopic image display device of claim 3, wherein each cell of the first group of cells is adjacent to cells of the second group of cells in column and row directions, and each cell of the second group of cells is adjacent to cells of the first group of cells in column and row directions.

5. The stereoscopic image display device of claim 1, wherein the controller is configured to output the first control signal during a first frame period and output the second control signal during a second frame period subsequent to the first frame period.

6. The stereoscopic image display device of claim 5, wherein the left-eye lens and the right-eye lens are configured to alternately turn on and off at a first frame interval.

7. A method for driving a stereoscopic image display device, the stereoscopic image display device comprising a plasma display panel comprising a plurality of cells for displaying images and spectacles including a left-eye lens and a right-eye lens, the method comprising:
displaying a left-eye image on a first group of cells of the plurality of cells, turning on the left-eye lens, and turning off the right-eye lens; and
displaying a right-eye image on a second group of cells of the plurality of cells, turning on the right-eye lens, and turning off the left-eye lens.

8. The method of claim 7, wherein the first and second groups of cells each include different cells of the plurality of cells.

9. The method of claim 7, wherein every cell adjacent to a cell of the first group of cells in row and column directions is a cell of the second group of cells.

10. The method of claim 7, wherein the left-eye lens is turned on in synchronization with the left-eye image, and the right-eye lens is turned on in synchronization with the right-eye image.

11. The method of claim 7, wherein the turning on the left-eye lens is performed during a first frame, and the turning on the right-eye lens is performed during a second frame subsequent to the first frame.

12. A stereoscopic image display device, comprising:
a plasma display panel comprising a plurality of cells; and
spectacles comprising a left-eye lens and a right-eye lens, each lens configured to alternately turn on and off,
wherein the stereoscopic image display device is configured to display an image on a first group of cells of the plurality of cells in response to an input image signal during a first period, display an image on a second group of cells of the plurality of cells in response to an input image signal during a second period, turn on either the left-eye lens or the right-eye lens in synchronization with a first point of time of the first period, and turn off either the left-eye lens or the right-eye lens in synchronization with a second point of time of the second period.

13. The stereoscopic image display device of claim 12, wherein the input image signal comprises left-eye and right-eye image signals and the device is configured to display a left-eye image on the first group of cells, display a right-eye image on the second group of cells, turn on the left-eye lens at the first point of time, and turn on the right-eye lens at the second point of time.

14. The stereoscopic image display device of claim 13, wherein the first point of time is a starting point of the first period, and the second point of time is a starting point of the second period.

15. The stereoscopic image display device of claim 12, wherein the first and second groups of cells each include a different plurality of the cells.
